(19) United States
(12) Patent Application Publication
(10) Pub. No.: US 2023/0400946 A1
(43) Pub. Date: Dec. 14, 2023

(54) Touch sensing circuit

(71) Applicant: SITRONIX TECHNOLOGY CORP., Hsinchu County (TW)

(72) Inventors: Chen-Yuan Yang, Hsinchu County (TW); Hung-Yen Tai, Hsinchu County (TW); Tzu-Hsuan Liu, Hsinchu County (TW)

(21) Appl. No.: 18/149,684

(22) Filed: Jan. 4, 2023

Related U.S. Application Data
(60) Provisional application No. 63/266,371, filed on Jan. 4, 2022.

(51) Int. Cl. G06F 3/041

(52) U.S. Cl. CPC G06F 3/04182

(57) ABSTRACT

The present application provides a touch sensing circuit, which comprises a plurality of analog front-end circuits, a noise processing circuit, and a compensation circuit. The analog front-end circuits generate a plurality of output signals according to a plurality of sensing signals. The noise processing circuit is coupled to the analog front-end circuits and generates an average noise according to the output signals. The compensation circuit is coupled to the noise processing circuit and compensates the output signals according to the average noise. By applying the touch sensing circuit of the present application, the influence of common-mode noise may be suppressed and the sensitivity of sensing touches may be improved.

### FIELD OF THE INVENTION

The present application relates generally to a sensing circuit, and particularly to a touch sensing circuit for sensing touches.

### BACKGROUND OF THE INVENTION

As to now time, most of electronic devices are equipped with touch display panels as the input interface for users' convenience in operating the electronic devices. As shown in FIG. 1, a touch display panel includes a pixel electrode substrate 10, a common electrode substrate 12, and a touch substrate 14. The pixel electrode substrate 10 and the common electrode substrate 12 act as the display panel, for example, the liquid crystal display panel or other display panels, for display images. A common voltage V_{COM} is provided to the common electrode substrate 12 through a buffer 13. A plurality of driving voltages are provided to the pixel electrode substrate 10. The driving voltages and the common voltage drive a plurality of pixels (not shown in figures) disposed on the pixel electrode substrate 10 for displaying images. The touch substrate 14 is disposed on the common electrode substrate 12 for sensing a user's touching.

Please refer to FIG. 1, again. The touch substrate 14 includes a plurality of driving lines TX₁-TX_{M} and a plurality of sensing lines RX₁-RX_{N} disposed crisscross for touch sensing. A touch sensing chip 16 is coupled to the driving lines TX₁-TX_{M} and the sensing lines RX₁-RX_{N}. The touch sensing chip 16 transmits a driving signal to the driving lines TX₁-TX_{M} for driving the touch substrate 14 to generate a plurality of sensing signals. The sensing signals are provided to the touch sensing chip 16 via the sensing lines RX₁-RX_{N}. The touch sensing chip 16 senses touches according to the sensing signals.

As shown in FIG. 1, a coupling capacitor C₁ is located between the pixel electrode substrate 10 and the common electrode substrate 12; a coupling capacitor C₂ is located between the common electrode substrate 12 and the touch substrate 14. Since there exist components such as connection pads and wires between the buffer 13 and the common electrode substrate 12, an impedance R is located therebetween. Under the influence of voltage drop caused by the impedance R, the common voltage V_{COM} provided to the common electrode substrate 12 is prone to interference and jitter. As the electronic components disposed on the pixel electrode substrate 10 are operating, the voltage disturbance will be occurred. The voltage disturbance will be transmitted to the common electrode substrate 12 via the coupling capacitor C₁. Then the voltage disturbance will interfere the common voltage V_{COM}, making the common voltage V_{COM} jitter. The jitter of the common voltage V_{COM} forms the display noise. The display noise may be transmitted to the sensing lines RX₁-RX_{N} of the touch substrate 14 via the coupling capacitor C 2 and influencing the sensing signals in the sensing lines RX₁-RX_{N}. Consequently, the sensitivity of the touch sensing chip 16 will be affected. More seriously, the touch sensing chip 16 will not be able to sense touches. The display noise influences the sensing signal of each of the sensing lines RX₁-RX_{N}. For the sensing signal of each of the sensing lines RX₁-RX_{N}, the influences are almost identical. Thereby, the display noise is a common-mode noise.

Please refer to FIG. 2, which shows a schematic diagram of the touch sensing chip and the touch display panel according to the prior art. The intersections of the driving lines TX₁-TX_{M} and the sensing lines RX₁-RX_{N} of the touch substrate 14 form a mutual capacitor. As shown in FIG. 2, the intersection of the driving line TX₁ and the sensing line RX₁ forms a mutual capacitor C_{M1}. One terminal of the mutual capacitor C_{M1} is coupled to the driving line TX₁ and receives the driving signal TX. The other terminal of the mutual capacitor C_{M1} is coupled to the sensing line RX₁, which is coupled to the connection pad 17 of the touch sensing chip 16 for transmitting the sensing signal to the touch sensing chip 16. One terminal of a coupling capacitor C_{RX1} is coupled to the sensing line RX₁. The other terminal of the coupling capacitor C_{RX1} receives the display noise. This coupling capacitor C_{RX1} is just the coupling capacitor C₂ shown in FIG. 1. The display noise is transmitted to the sensing line RX₁ via the coupling capacitor C_{RX1} and influences the sensing signal in the sensing line RX₁.

The touch sensing chip 16 includes a plurality of analog front-end circuits 18 coupled to the sensing lines RX₁-RX_{N} for generating the output signals Vₒᵤₜ according to the sensing signals. As shown in FIG. 3, the amplitude of the output signal Vₒᵤₜ generated by the analog front-end circuit 18 according to the sensing signal influenced by the display noise will exceed the maximum operating amplitude V_{DD} or the minimum operating amplitude 0. The exceeding parts of the output signal Vₒᵤₜ will be cut off, making the touch sensing chip 16 unable to sense touches. The dashed waveforms shown in FIG. 3 and FIG. 4 are the output signals Vₒᵤₜ without touch, while the solid waveforms are the output signals Vₒᵤₜ with touch.

Accordingly, the present application provides a touch sensing circuit, which may suppress the influence of the common-mode noises and improve the sensitivity of sensing touches.

### SUMMARY OF THE INVENTION

An objective of the present application is to provide a touch sensing circuit, which may generate an average noise for compensating signal. Thereby, the influence of the common-mode noise may be suppressed and the sensitivity of sensing touches may be improved.

The present application provides a touch sensing circuit, which comprises a plurality of analog front-end circuits, a noise processing circuit, and a compensation circuit. The analog front-end circuits generate a plurality of output signals according to a plurality of sensing signals. The noise processing circuit is coupled to the analog front-end circuits and generates an average noise according to the output signals. The compensation circuit is coupled to the noise processing circuit and compensates the output signals according to the average noise.

The present application further provides another touch sensing circuit, which comprises a plurality of analog front-end circuits, an analog-to-digital converter, and a digital signal processor. The analog front-end circuits generate a plurality of output signals according to a plurality of sensing signals. The analog-to-digital converter converts the output signals for generating a plurality of digital signals. The digital signal processor is coupled to the analog-to-digital converter, generates an average noise according to the digital signals, and compensates the digital signals according to the average noise.

### BRIEF DESCRIPTION OF DRAWINGS

FIG. 1 shows a schematic diagram of the touch display panel according to the prior art;

FIG. 2 shows a schematic diagram of the touch sensing chip and the touch display panel according to the prior art;

FIG. 3 shows waveforms of the output signal of the touch sensing chip according to the prior art;

FIG. 4 shows cutoff waveforms of the output signal of the touch sensing chip according to the prior art in FIG. 3;

FIG. 5 shows a block diagram of the touch sensing circuit according to an embodiment of the present application;

FIG. 6 shows a schematic diagram of the touch sensing circuit according to an embodiment of the present application; and

FIG. 7 shows a schematic diagram of the touch sensing circuit according to another embodiment of the present application.

### DETAILED DESCRIPTION OF THE INVENTION

In order to make the structure and characteristics as well as the effectiveness of the present application to be further understood and recognized, the detailed description of the present application is provided as follows along with embodiments and accompanying figures.

In the specifications and subsequent claims, certain words are used for representing specific devices. A person having ordinary skill in the art should know that hardware manufacturers might use different nouns to call the same device. In the specifications and subsequent claims, the differences in names are not used for distinguishing devices. Instead, the differences in functions are the guidelines for distinguishing. In the whole specifications and subsequent claims, the word “comprising/including” is an open language and should be explained as “comprising but not limited to”. Besides, the word “couple” includes any direct and indirect electrical connection. Thereby, if the description is that a first device is coupled to a second device, it means that the first device is connected electrically to the second device directly, or the first device is connected electrically to the second device via other device or connecting means indirectly.

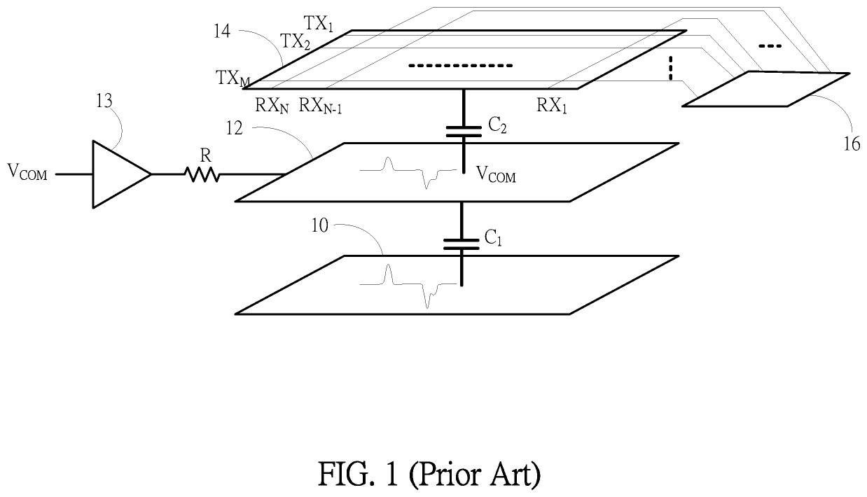

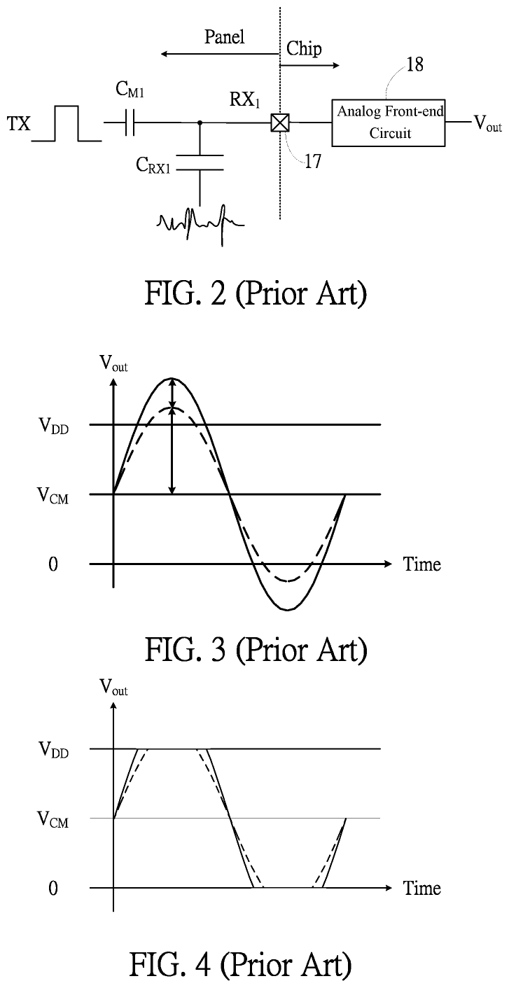

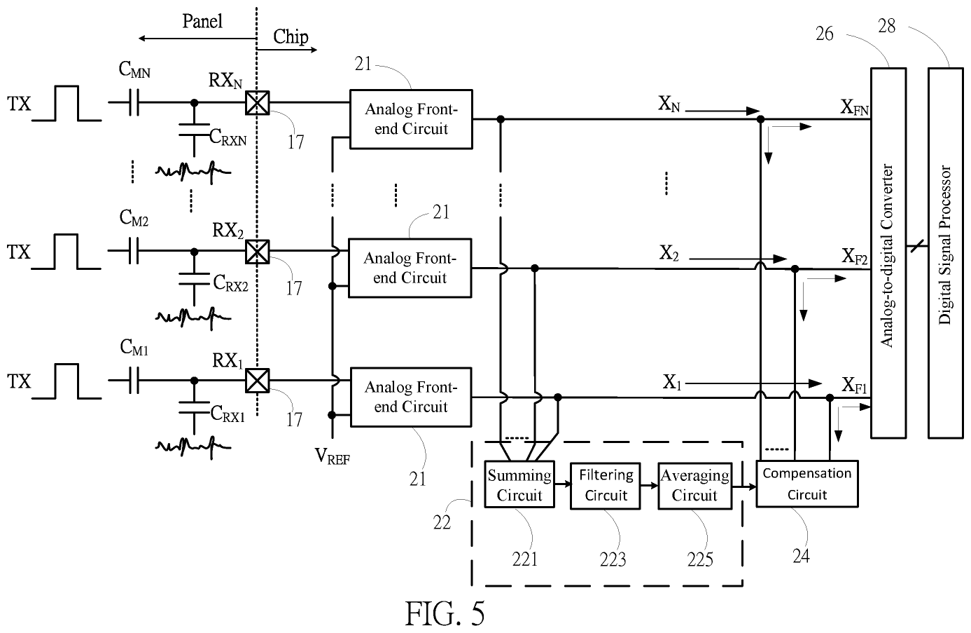

Please refer to FIG. 5, which shows a block diagram of the touch sensing circuit according to an embodiment of the present application. As shown in the figure, the touch sensing circuit according to the present application comprises a plurality of analog front-end circuits 21, a noise processing circuit 22, a compensation circuit 24, an analog-to-digital converter 26, and a digital signal processor 28. As shown in FIG. 1, the touch sensing circuit is coupled to the touch panel through the connection pad 17 and to the sensing lines RX₁-RX_{N} of the touch panel for sensing touches. According to an embodiment of the present application, the touch sensing circuit may be a touch sensing chip. The analog front-end circuits 21 are coupled to the sensing lines RX₁-RX_{N} via the connection pads 17, receive the sensing signals of the sensing lines RX₁-RX_{N}, and generate a plurality of output signals X₁-X_{N} according to the sensing signals. The analog front-end circuits 21 receives a reference signal V_{REF} and transfer charges according to the sensing signals for generating the output signals X₁-X_{N}.

Please refer to FIG. 5, again. The noise processing circuit 22 includes a summing circuit 221, a filtering circuit 223, and an averaging circuit 225. The summing circuit 221 is coupled to the analog front-end circuits 21 and summing the output signals X₁-X_{N} to give an output summation signal. Since the output signals X₁-X_{N} contain common-mode noises and the common-mode noises of each of the output signals X₁-X_{N} are almost identical, the output summation signal equivalently contains N common-mode noises. The filtering circuit 223 is coupled to the summing circuit 221 and filters the output summation signal for generating a noise summation signal. When a touch occurs, one or more of the output signals X₁-X_{N} will contain the high-frequency component generated by the touch. The filtering circuit 223 may filter out the high-frequency component in the output summation signal, leaving the common-mode noises and generating a noise summation signal, which contains N common-mode noises. According to an embodiment of the present application, the filtering circuit 223 may be a low-pass filter. The averaging circuit 225 is coupled to the filtering circuit 223 and averages the noise summation signal to generate an average noise, and thus giving an amplitude of one common-mode noise. According to the above description, the noise processing circuit 22 is coupled to the analog front-end circuits 21 and generates the average noise according to the output signals X₁-X_{N}.

The compensation circuit 24 is coupled to the analog front-end circuits 21 and the averaging circuit 225 of the noise processing circuit 22 and compensates the output signals X₁-X_{N} according to the average noise for generating the output signals X_{F1}-X_{FN}. According to the average noise, the compensation circuit 24 removes the common-mode noises from the output signals X₁-X_{N}. If the common-mode noises are positive, the average noise is subtracted from the output signals X₁-X_{N} to give the output signals X_{F1}-X_{FN}. If the common-mode noises are negative, the average noise is added to the output signals X₁-X_{N} to give the output signals X_{F1}-X_{FN}. The compensated output signals X_{F1}-X_{FN} contains no common-mode noise. Thereby, the influence of the common-mode noises on touch sensing may be suppressed. When the analog front-end circuits 21 generate the output signals X₁-X_{N}, the compensation circuit 24 can compensate the output signals X₁-X_{N} real-timely according to the average noise for generating the output signals X_{F1}-X_{FN} and driving the amplitudes of the output signals X_{F1}-X_{FN} not exceeding the amplitude operating range of the analog front-end circuits 21.

Please refer again to FIG. 5. The analog-to-digital converter 26 converts the output signals X_{F1}-X_{FN} to generate a plurality of digital signals. The digital signal processor 28 is coupled to the analog-to-digital converter 26 and generates a touch signal according to the digital signals and a threshold value. The touch signal indicates whether a touch occurs. When a touch event occurs, for example, the sensing line RX₁ is touched, the digital signal converted from the output signal X_{F1} by the analog-to-digital converter 26 will be greater than the threshold value, meaning that the sensing line RX₁ is touched. When the digital signal is smaller than the threshold value, it means that no touch occurs.

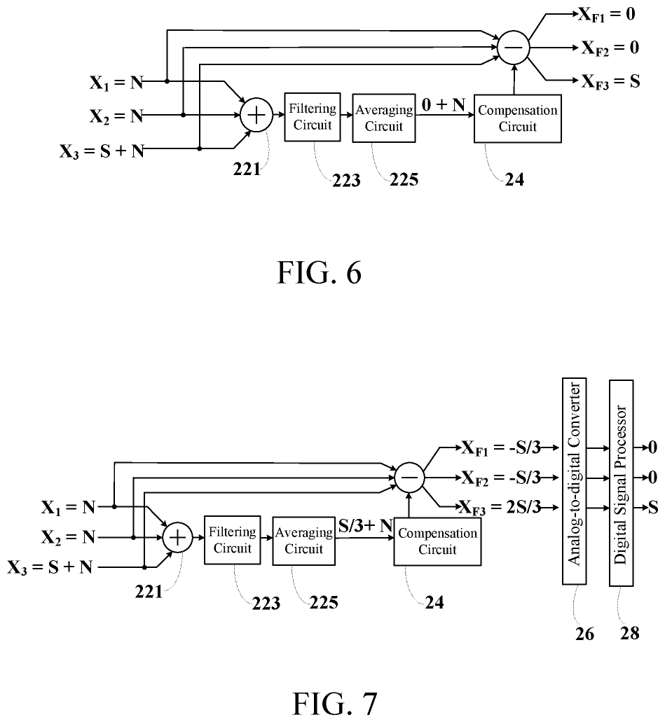

Please refer to FIG. 6, which shows a schematic diagram of the touch sensing circuit according to an embodiment of the present application. According to the present embodiment, the touch substrate includes three sensing lines RX₁-RX₃. Besides, as an example, the sensing line RX₃ is touched. As shown in the figure, the analog front-end circuits 21 coupled to the sensing lines RX₁-RX₃ generate the output signals X₁-X₃ according to the sensing signals in the sensing lines RX₁-RX₃. Because the sensing lines RX₁-RX₂ are not touched and the sensing line RX₃ is touched, the output signals X₁-X₂ contain the common-mode noise N and the output signal X₃ contains the common-mode noise N and the touch signal S. The summing circuit 221 sums the output signals X₁-X₃ and generates the output summation signal. The filtering circuit 223 filters the output summation signal for filtering out the touch signal S and generating the noise summation signal. The averaging circuit 225 averages the noise summation signal for generating the average noise, which includes no touch signal S and a common-mode noise N. The compensation circuit 24 compensates the output signals X₁-X₃ according to the average noise for generating the output signals X_{F1}-X_{F3}. According to the present embodiment, the average noise is positive, so the compensation circuit 24 subtracts the average noise from the output signals X₁-X₂. Thereby, the generated output signals X_{F1}-X_{F2} are 0. On the other hand, the output signal X_{F3} contains the touch signal S but no common-mode noise. The digital signal generated by converting the output signal X_{F3} by the analog-to-digital converter 26 will be greater than the threshold value, indicating that the sensing line RX₃ is touched.

Please refer to FIG. 7, which shows a schematic diagram of the touch sensing circuit according to another embodiment of the present application. As shown in the figure, the difference between the present embodiment and the embodiment as shown in FIG. 6 is that the filtering circuit 223 does not filter out the touch signal S as well as the filtering circuit 223 only transmits the output summation signal to the averaging circuit 225. The average noise generated by the averaging circuit 225 by averaging the output summation signal includes ⅓ of the touch signal S, namely, S/3, and a common-mode noise N. The compensation circuit 24 compensates the output signals X₁-X₃ according to the average noise for generating the output signals X_{F1}-X_{F3}. The output signals X_{F1}-X_{F2} are negative ⅓ of the touch signal S, namely, −S/3. On the other hand, the output signal X_{F3} is positive ⅔ of the touch signal S, namely, 2S/3. The analog-to-digital converter 26 converts the output signals X_{F1}-X_{F3} and generates three digital signals. The digital signal processor 28 determines an adjusting value according to the three digital signals and adjusts the three digital signals according to the adjusting value. According to the present embodiment, use the difference between the minimum digital signal and 0 as the adjusting value. In other words, the negative ⅓ of the touch signal S is used as the adjusting value. Thereby, the digital signals corresponding to the output signals X_{F1}-X_{F2} are adjusted to 0; the digital signal corresponding to the output signal X_{F3} is adjusted to S. Then, the adjusted digital signals are compared with the threshold value for judging touches. According to the above description, in the embodiment of FIG. 7, the filtering circuit 223 is not required. The averaging circuit 225 may be coupled to the summing circuit 221 and average the output summation signal for generating the average noise.

According to another embodiment of the present application, the digital signal processor 28 may adjust the threshold value instead of the digital signals. According to an embodiment of the present application, use the difference between the minimum digital signal and 0 as the adjusting value. In other words, the negative ⅓ of the touch signal S is used as the adjusting value for lowering the threshold value. Then, the digital signals are compared with the adjusted threshold value for generating the touch signal and judging touches.

According to another embodiment of the present application, the summing circuit 221, the filtering circuit 223, the averaging circuit 225, and the compensation circuit 24 in the embodiment of FIG. 7 are not required. The digital signal processor 28 receives and sums the digital signals for generating and averaging a digital summation signal and giving the average noise. The average noise is similar to the average noise shown in the embodiment of FIG. 7 and includes ⅓ of the touch signal S, namely, S/3, and a common-mode noise N. The digital signal processor 28 compensates the digital signals according to the average noise. After compensation, the digital signals corresponding to the output signals X_{F1}-X_{F2} become negative ⅓ of the touch signal, namely, −S/3; the digital signal corresponding to the output signal X_{F3} becomes positive ⅔ of the touch signal S, namely, 2S/3. Afterwards, as described above, the digital signal processor 28 determines the adjusting vale according to the compensated digital signals, and adjusts the compensated digital signals or the threshold value for generating the touch signal and judging touches.

Accordingly, the present application conforms to the legal requirements owing to its novelty, nonobviousness, and utility. However, the foregoing description is only embodiments of the present application, not used to limit the scope and range of the present application. Those equivalent changes or modifications made according to the shape, structure, feature, or spirit described in the claims of the present application are included in the appended claims of the present application.

1. A touch sensing circuit, comprising:
a plurality of analog front-end circuits, generating a plurality of output signals according to a plurality of sensing signals;
a noise processing circuit, coupled to said analog front-end circuits, and generating an average noise according to said output signals; and
a compensation circuit, coupled to said noise processing circuit, and compensating said output signals according to said average noise.

2. The touch sensing circuit of claim 1, wherein said noise processing circuit comprises:
a summing circuit, coupled to said analog front-end circuits, and summing said output signals for generating an output summation signal;
a filtering circuit, coupled to said summing circuit, and filtering said output summation signal for generating a noise summation signal; and
an averaging circuit, coupled to said filtering circuit, and averaging said noise summation signal for generating said average noise.

3. The touch sensing circuit of claim 1, further comprising:
an analog-to-digital converter, converting said output signals compensated by said compensation circuit for generating a plurality of digital signals; and
a digital signal processor, coupled to said analog-to-digital converter, and generating a touch signal according to said digital signals and a threshold value.

4. The touch sensing circuit of claim 1, wherein said noise processing circuit comprises:
a summing circuit, coupled to said analog front-end circuits, and summing said output signals for generating an output summation signal; and
an averaging circuit, coupled to said summing circuit, and averaging said output summation signal for generating said average noise.

5. The touch sensing circuit of claim 4, further comprising:
an analog-to-digital converter, converting said output signals compensated by said compensation circuit for generating a plurality of digital signals; and
a digital signal processor, coupled to said analog-to-digital converter, adjusting said digital signals, and generating a touch signal according to said adjusted digital signals and a threshold value.

6. The touch sensing circuit of claim 5, wherein said digital signal processor determines an adjusting value according to said digital signals and adjusts said digital signals according to said adjusting value.

7. The touch sensing circuit of claim 4, further comprising:
an analog-to-digital converter, converting said output signals compensated by said compensation circuit for generating a plurality of digital signals; and
a digital signal processor, coupled to said analog-to-digital converter, adjusting a threshold value, and generating a touch signal according to said digital signals and said adjusted threshold value.

8. The touch sensing circuit of claim 7, wherein said digital signal processor determines an adjusting value according to said digital signals and adjusts said threshold value according to said adjusting value.

9. A touch sensing circuit, comprising:
a plurality of analog front-end circuits, generating a plurality of output signals according to a plurality of sensing signals;
an analog-to-digital converter, converting said output signals for generating a plurality of digital signals; and
a digital signal processor, coupled to said analog-to-digital converter, generating an average noise according to said digital signals, and compensating said digital signals according to said average noise.

10. The touch sensing circuit of claim 9, wherein said digital signal processor sums said digital signals for generating a digital summation signal, and averages said digital summation signal for generating said average noise.

11. The touch sensing circuit of claim 9, wherein said digital signal processor further adjusts said compensated digital signals, and generates a touch signal according to said adjusted digital signals and a threshold value.

12. The touch sensing circuit of claim 11, wherein said digital signal processor determines an adjusting value according to said compensated digital signals, and adjusts said compensated digital signals according to said adjusting value.

13. The touch sensing circuit of claim 9, wherein said digital signal processor adjusts a threshold value, and generates a touch signal according to said compensated digital signals and said adjusted threshold value.

14. The touch sensing circuit of claim 13, wherein said digital signal processor determines an adjusting value according to said compensated digital signals, and adjusts said threshold value according to said adjusting value.
